(19) United States
(12) Patent Application Publication
(10) Pub. No.: US 2025/0323368 A1
(43) Pub. Date: Oct. 16, 2025

(54) BATTERY SYSTEM WITH IMPROVED CELL STACK FRAME

(71) Applicant: SAMSUNG SDI CO., LTD., Yongin-si (KR)

(72) Inventor: Martin BLODER, Sinabelkirchen (AT)

(21) Appl. No.: 18/886,573

(22) Filed: Sep. 16, 2024

(30) Foreign Application Priority Data
Apr. 10, 2024 (EP) 24169463.7

(51) Int. Cl. H01M 50/242; B60L 50/64; H01M 50/209; H01M 50/211

(52) U.S. Cl. CPC H01M 50/242; B60L 50/64; H01M 50/209; H01M 50/211; H01M 2220/20

(57) ABSTRACT

A battery system includes: a cell stack including a plurality of battery cells; and a cell stack frame accommodating the cell stack. The cell stack frame includes a deformable end plate including a base portion and a Belleville spring portion extending from the base portion towards the cell stack that exerts pressure onto the cell stack.

### CROSS-REFERENCE-TO RELATED APPLICATION

The present application claims priority to and the benefit of European Patent Application Ser. No. 24/169,463.7, filed on Apr. 10, 2024, in the European Patent Office, the entire disclosure of which is incorporated herein by reference.

### BACKGROUND

### 1. Field

Aspects of embodiments of the present disclosure relate to a battery system with an improved cell stack frame.

### 2. Description of the Related Art

Recently, vehicles for transportation of goods and people have been developed that use electric power as a source for motion. Such an electric vehicle is an automobile that is propelled, permanently or temporarily, by an electric motor using energy stored in rechargeable (or secondary) batteries. An electric vehicle may be solely powered by batteries (a so-called Battery Electric Vehicle or “BEV”) or may include a combination of an electric motor and, for example, a conventional combustion engine (a so-called Plugin Hybrid Electric Vehicle or “PHEV”). BEVs and PHEVs use high-capacity rechargeable batteries that are designed to provide power for propulsion over sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in (e.g., is accommodated in) a casing and electrode terminals, which are positioned on the outside of the casing, establish an electrically conductive connection 1 to the electrodes. The casing may have, for example, a cylindrical or rectangular shape.

A battery module is generally formed of a plurality of battery cells connected together in series or in parallel. For example, the battery module is formed by interconnecting the electrode terminals of the plurality of battery cells, in a number and configuration according to a desired amount of power, to realize a high-power rechargeable battery.

Battery modules can be constructed in either a block design or a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single (e.g., individual) battery cells. The battery modules, or the respective battery cells, may be configured in a series, parallel, or a mixture of both to provide the desired voltage, capacity, and/or power density. Components of a battery pack include the individual battery modules and interconnects, which provide electrical conductivity between the battery modules.

The battery cells of a battery pack may be arranged by stacking the battery cells onto each other or by arranging the battery cells in a row to form a cell stack. Neighboring battery cells in a cell stack may be distanced from one another via cell spacers. The cell stack may be placed inside a cell stack frame delimiting the battery cells to the outside. The cell stack frame may expert pressure (e.g., a predetermined pressure) onto the battery cells to compensate for possible production tolerances and swelling of the battery cells to ensure optimal operation of the battery cells over their lifetime.

Conventional battery systems typically include cell stack frames with end plates that exert pressure onto the cell stack with a rigid linear or progressive elastic pressure characteristic. Such rigid frameworks may be susceptible to length or positioning deviations because a small displacement may cause a large (or steep) increase or decrease of force applied on the cell stack, which may, in turn, reduce the performance of the cell stack. To mitigate this, very precise and, therefore, expensive production tolerances must be met or other costly and intricate ways of adjusting pre-tension applied onto the cell stack via positioning of the end plate during assembly have to be implemented. However, such end plates may not be able to ensure that the correct amount of pressure is applied to the cell stack over its entire lifetime.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to embodiments of the present application, a battery system with an improved cell stack frame is provided that ensures correct pressure conditions for optimal operation of the battery cells over their entire lifetime.

According to one embodiment of the present disclosure, a battery system includes a cell stack including a plurality of arranged battery cells and a cell stack frame accommodating the cell stack. The cell stack frame includes a deformable end plate including a base portion and a Belleville spring portion extending from the base portion towards the cell stack that exerts pressure onto the cell stack.

According to another embodiment of the present disclosure, the deformable end plate has a rectangular shape corresponding to a shape of an interior space of the cell stack frame that accommodates the cell stack.

According to another embodiment of the present disclosure, the base portion of the deformable end plate is fixed to side walls of the cell stack frame.

According to another embodiment of the present disclosure, the Belleville spring portion of the deformable end plate includes four or more wall elements extending from the base portion of the deformable end plate towards a center of the Belleville spring portion.

According to another embodiment of the present disclosure, the Belleville spring portion has a central opening at a center of the Belleville spring portion.

According to another embodiment of the present disclosure, the Belleville spring portion has slots extending outwardly from the central opening of the Belleville spring portion.

According to another embodiment of the present disclosure, the Belleville spring portion has slots extending inwardly from the lateral edges of the Belleville spring portion.

Another embodiment of the present disclosure refers to an electric vehicle including the battery system as described above.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic top view of a battery system according to an embodiment.

FIGS. 2A-2D are a perspective view, a front view, and two sectional views, respectively, of a deformable end plate of the battery system according to an embodiment.

FIGS. 3A-3D are a perspective view, a front view, and two sectional views, respectively, of a deformable end plate according to another embodiment.

FIGS. 4A-4D are a perspective view, a front view, and two sectional views, respectively, of a deformable end plate according to another embodiment.

FIGS. 5A-5C include schematic top views of battery systems having different cell stack lengths.

FIG. 6 is a diagram showing a force to elongation (or displacement) ratio for the battery system.

### DETAILED DESCRIPTION

Reference will now be made, in detail, to embodiments, examples of which are illustrated in the accompanying drawings. Aspect and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the term “substantially,” “about,” and similar terms are used as terms of approximation and not as terms of degree and are intended to account for inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

A battery system, according to an embodiment of the present disclosure, includes a plurality of battery cells, for example, prismatic or pouch type battery cells. The battery cells are arranged to form a cell stack, for example, by stacking the battery cells onto each other or arranging the battery cells in a row. Cell spacers may be disposed in-between adjacent or neighboring battery cells. Thus, neighboring battery cells of the cell stack may be distanced (or spaced) from one another via a cell spacer. The cell stack may form one or more battery packs.

The cell stack is disposed inside a cell stack frame. The cell stack frame includes at least one deformable end plate. The cell stack frame may include two end plates and two side walls connecting the end plates. One or both of the end plates may be deformable end plates. The cell stack arranged inside the cell stack frame may, thus, be delimited from four sides by the end plates and side walls. The cell stack frame may further include a top cover and a bottom cover such that the cell stack may be delimited (or covered) from all six sides. The deformable end plate may be fixed to the side walls (and/or the top cover and bottom cover) by, for example, welding, riveting, or screwing. The cell stack frame may delimit the cell stack from an outside, for example, from an exterior environment of the cell stack. The deformable end plate may form an outer delimitation (or outer surface) of the cell stack frame. Also, the other end plate and/or the side walls may also form the outer delimitation of the cell stack frame. In other words, the cell stack frame, for example, the two end plates and two side walls, may delimit an interior space of the cell stack frame from the exterior, and in the cell stack is arranged in the interior space. One or both of the end plates may exert pressure onto the cell stack.

The deformable end plate includes a base portion and a Belleville spring portion and, thus, is deformable. In other words, the deformable end plate is deformable insofar as the Belleville spring portion is deformable. The base portion may be rigid/non-deformable. The Belleville spring portion is a portion of the deformable end plate that is shaped as a Belleville spring. The deformable end plate, in the mounted position, exerts pressure onto the cell stack via its Belleville spring portion. Thereby, the Belleville spring portion may be deformed. The Belleville spring portion may be an intrinsic (or integral) part of the deformable end plate. For example, the base portion and the Belleville spring portion may be formed together in one piece, for example, from metal, such as, sheet metal. The metal may be, for example, steel or aluminum. The deformable end plate exerts pressure onto the cell stack via its Belleville spring portion while being supported or fixed to other parts of the cell stack frame, for example, to the side walls via its base portion. The cell stack frame pre-tensions the cell stack. In an embodiment, both of the end plates are deformable end plates, for example, both of the end plates may include a base portion and a Belleville spring portion.

In contrast to conventional battery systems, which may include end plates having a rigid linear or progressive elastic pressure characteristic, the deformable end plate according to embodiments of the present disclosure has, due to the Belleville spring portion, a degressive deformation characteristic. The degressive deformation characteristic may include a low, or even flat, force-displacement-inclination in the relevant pre-tensioning force range for prismatic or pouch type cells. With the deformable end plate having the Belleville spring portion, inevitable tolerances for both the elements of the cell stack as well as the elements of the cell stack frame can be compensated for by the inherent deformation ability of the deformable end plate. This may eliminate the need for additional shimming or other adjustment work during cell stacking. Further, any swelling (due to, for example, ageing) of the battery cells of the cell stack may also be compensated. Also, loads which may occur during accidents may be compensated. Due to said tolerances and swelling, a length of the cell stack may vary. However, the deformable end plate may be configured to exert a substantially constant pressure via its Belleville spring portion onto the cell stack independent of the length of the cell stack. Thus, the cell stack may be pressurized in the optimum range for peak performance, ensuring reliable and safe operation through all its life cycle until end of life. The deformable end plate, according to embodiments of the present disclosure, is that the rest of the cell stack frame may be rigid to fulfill any structural requirements of the battery pack. Due to its Belleville spring portion, the end plate may always be mounted at the same or substantially the same fixture position without adjustments while maintaining pressure onto the cell stack in the desired range.

According to an embodiment, the deformable end plate has a rectangular shape corresponding to a shape of an interior space of the cell stack frame that accommodates the cell stack. As described above, the two end plates and two side walls of the cell stack frame may delimit an interior space in which the cell stack is disposed. The interior space may have a rectangular shape. In other words, an interior cross-sectional shape of the cell stack frame may be rectangular. The deformable end plate may have a correspondingly formed cross-section. The deformable end plate having a rectangular shape/cross-section may indicate that the base portion and/or the Belleville spring portion has a rectangular shape/cross-section. The deformable end plate having such a shape may sufficiently delimit the cell stack frame to the outside, may be reliably fixed to the side wall, and/or may ensure that pressure is exerted.

According to an embodiment, the base portion of the deformable end plate is fixed to side walls of the cell stack frame. The deformable end plate, exerting the pressure onto the cell stack via its Belleville spring portion, may thus be supported by the side walls of the cell stack frame. For example, the side walls of the cell stack frame may act as a counter-bearing surface or structure. The base portion may be rigid, for example, substantially non-deformable. The base portion may be, for example, welded, riveted, or screwed to the side walls of the cell stack frame. A snap-fit connection between the base portion and the side walls is also possible. The side walls of the cell stack frame may include first connecting elements (e.g., first connectors), and the base portion of the deformable end plate may include second connecting elements (e.g., second connectors) interacting with the first connecting elements. Thus, the base portion may be fixed to the side walls via the first and second first connecting elements. The deformable end plate may be fixed to the side walls at a specific position such that the base portion is immoveable. The base portion may introduce (or may provide or transfer) the counter-forces resulting from the Belleville spring portion pressing onto the cell stack into the side walls.

According to an embodiment, the Belleville spring portion of the deformable end plate includes four (or more) wall elements extending from the base portion of the deformable end plate towards a center of the Belleville spring portion, or the center of the deformable end plate. As mentioned, the deformable end plate may have a rectangular shape. In an embodiment, the base portion has a rectangular shape with four lateral edges, and from each of the lateral edges, one of the four (or more) wall elements of the Belleville spring portion extends towards a center of the deformable end plate/Belleville spring portion. The wall elements may be inclined with respect to a stacking direction, for example, towards the cell stack. In other words, the wall elements may extend obliquely towards the cell stack. The wall elements may thereby form the Belleville spring. Such a deformable end plate may fit well and may be well suited for exerting pressure onto the cell stack.

According to an embodiment, the Belleville spring portion has a central opening at a center of the Belleville spring portion. The central opening may be a through-hole. The Belleville spring portion of the deformable end plate may include the above-mentioned four wall elements extending from the base portion of the deformable end plate towards a center of the Belleville spring portion, and the central opening may be arranged at the center thereof. The central opening may improve the degressive deformation characteristic of the Belleville spring portion.

According to an embodiment, the Belleville spring portion has slots extending outwardly (e.g., extending radially outwardly) from the center or central opening of the Belleville spring portion. The slots may be evenly distributed around the central opening. The slots may extend from the center or central opening towards the lateral edges, for example, an outer circumference, of the Belleville spring portion. The slots may extend from the center or central opening towards the lateral edges across about 40% to 70%, for example, about 60%, of the distance between the center or central opening and the respective lateral edge. The slots may improve the degressive deformation characteristic of the Belleville spring portion.

According to an embodiment, the Belleville spring portion has slots extending inwardly from the lateral edges, for example, the outer circumference, of the Belleville spring portion. The slots extending inwardly from the lateral edges may extend towards a center or central opening of the Belleville spring portion. The slots may extend from the lateral edges towards the center or central opening towards across about 40% to 70%, for example, about 60%, of the distance between the respective lateral edge and the center or central opening. The slots may also extend along the base portion of the deformable end plate. The slots may improve the degressive deformation characteristic of the Belleville spring portion.

According to an embodiment, the Belleville spring portion has first slots extending outwardly from the central opening and second slots extending inwardly from the lateral edges. Thus, the Belleville spring portion may include both slots mentioned above. The first slots and second slots may be arranged alternately around the center of the Belleville spring portion. The slots may improve the degressive deformation characteristic of the Belleville spring portion.

Embodiments of the present disclosure also pertain to an electric vehicle including a battery system according to the present disclosure, for example, a battery system as described above.

According to another embodiment of the present disclosure, a method for assembling a battery system according to an embodiment of the present disclosure, that is, a battery system as described above, is provided. In one embodiment, the cell stack frame may be provided with the deformable end plate placed in its fixture/mounting position. For example, the deformable end plate may in the fixture/mounting position be fixed to the side walls of the cell stack frame, as described above. Subsequently, the cell stack may be compressed and then inserted, in its pre-compressed state, into the cell stack frame with the deformable end plate already at its fixture/mounting position. The cell stack may then be released and may expand until it contacts the deformable end plate such that the deformable end plate exerts pressure onto the cell stack via its Belleville spring portion. In another embodiment, the cell stack frame may be provided without the deformable end plate placed in its fixture/mounting position. The cell stack may be inserted into the cell stack frame without pre-compression. Subsequently, the deformable end plate may be placed in its fixture/mounting position, thereby compressing the cell stack, for example, exerting pressure onto the cell stack via the Belleville spring portion. In yet another embodiment, the cell stack frame is provided with a deformable end plate already in its fixture/mounting possession. The cell stack may then be inserted in the frame without being pre-compressed, and subsequently, the non-deformable or deformable end plate on the opposite side of the stack is pushed to its final mounting position, thereby compressing the cell stack and deforming the deformable end plate(s).

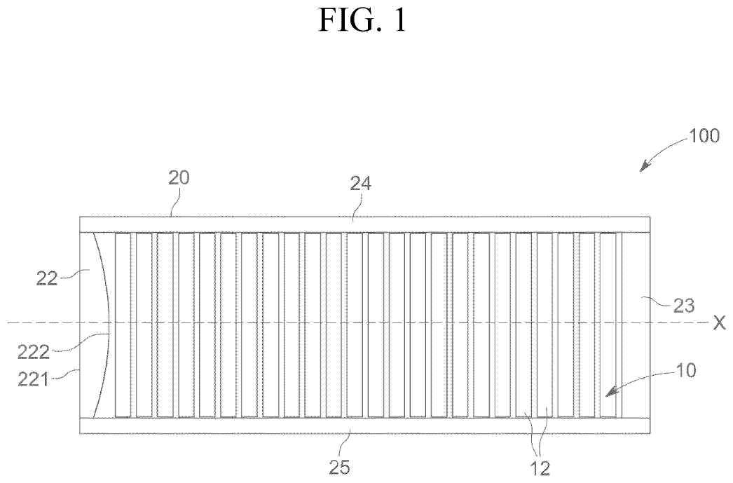

FIG. 1 is a schematic top view of a battery system 100 according to an embodiment. The battery system 100 includes plurality of battery cells 12 arranged to form a cell stack 10 and a cell stack frame 20 accommodating the cell stack 10. The battery cells 12 are stacked (or arranged) along a stacking axis X.

The cell stack frame 20 includes two end plates 22, 23 and two side walls 24, 25 connecting the end plates 22, 23. The end plates 22, 23 and side walls 24, 25 delimit the cell stack 10 on four sides, as shown in, for example, FIG. 1. The cell stack frame 20 may further include a top cover and a bottom cover to completely encase the cell stack 10.

The end plate 22 is a deformable end plate including a base portion 221 and a Belleville spring portion 222. The base portion 221 is fixed to the side walls 24, 25 on opposite sides of the base portion 221 via its lateral edges 223, for example, via screws or rivets at a fixture position. The deformable end plate 22 has a rectangular shape corresponding to a shape of an interior space of the cell stack frame 20 that accommodates the cell stack 10. The end plate 23 may also be a deformable end plate (e.g., the end plate 23 may have the same or substantially similar construction as the end plate 22).

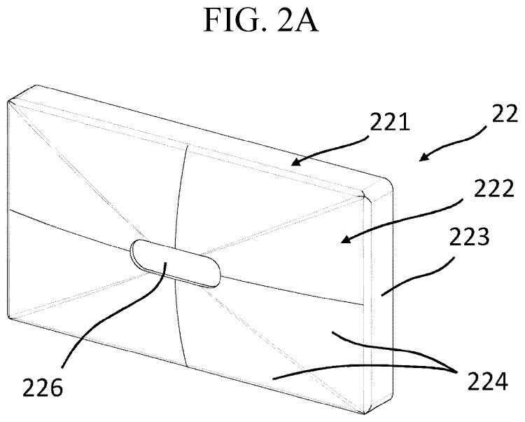

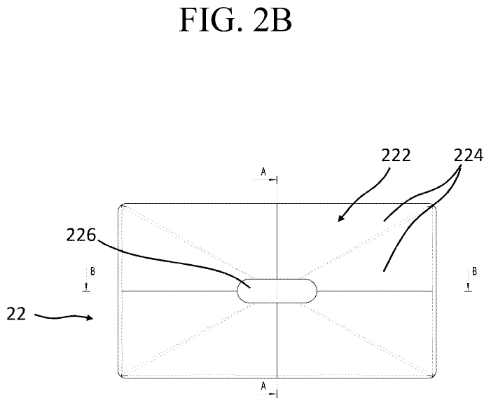

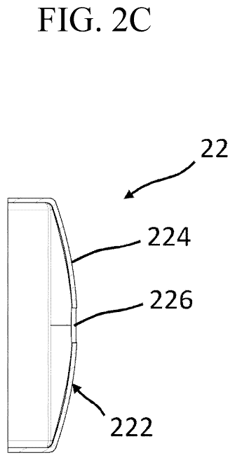

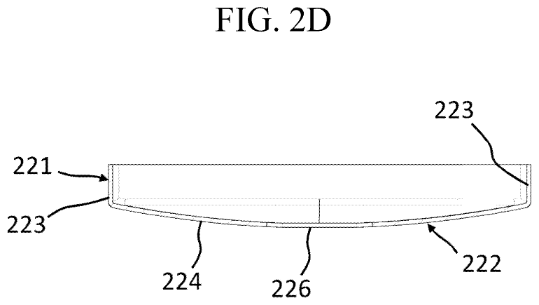

Different embodiments of the deformable end plate 22 are shown in FIGS. 2 to 4. Each of these Figures shows the respective end plate 22 in a perspective (isometric) view, a front view, and in two sectional views-a first sectional view taken along the line A-A shown in the front view and a second sectional view taken along the line B-B shown in the front view.

As shown in these Figures, the base portion 221 has a rectangular shape with four lateral edges 223, and from each of the lateral edges 223, one of four wall elements 224 of the Belleville spring portion 222 extends towards a center of the Belleville spring portion 222. A central opening 226 is arranged at the center of the Belleville spring portion 222.

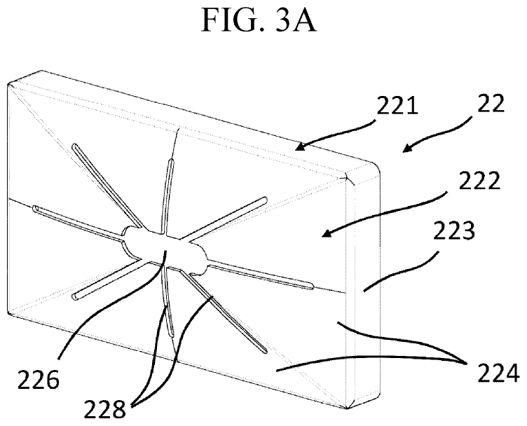

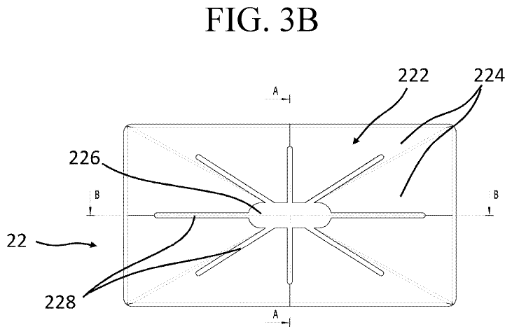

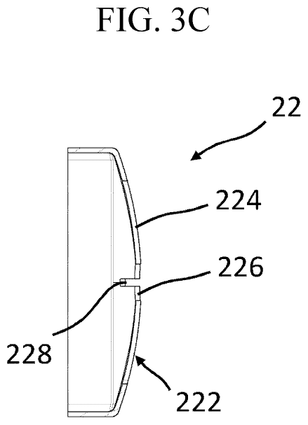

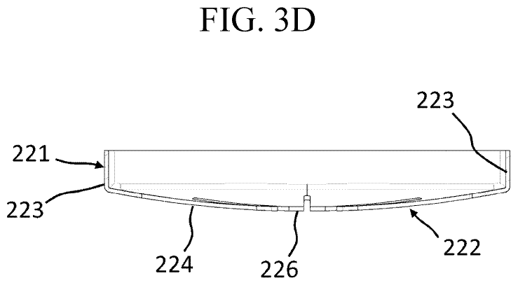

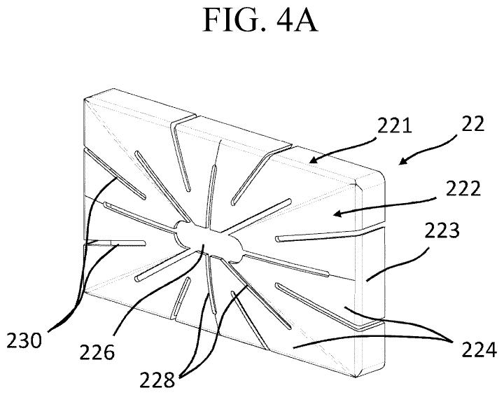

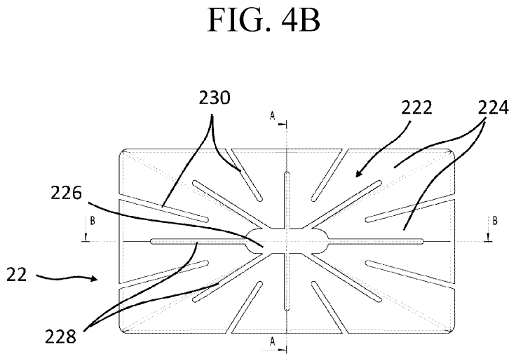

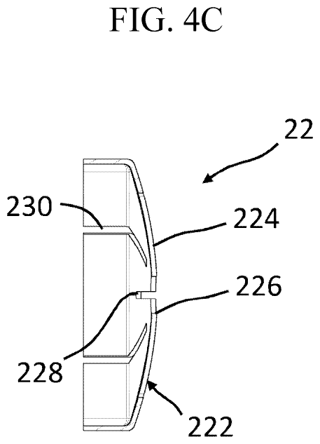

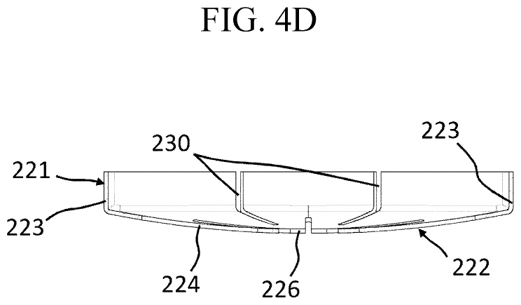

In the embodiment shown in FIG. 3, the Belleville spring portion 222 has slots 228 extending outwardly from the central opening 226 towards the lateral edges 223, which may also be understood as lateral edges 223 of the Belleville spring portion 222. In the embodiment shown in FIG. 4, the Belleville spring portion 222 has the slots (e.g., first slots) 228 and further slots (e.g., second slots) 230 extending inwardly from 1 the lateral edges 223 towards the central opening 226. The slots (e.g., the second slots) 230 may extend along the entire length of the lateral edges 223 and, thus, of the base portion 221.

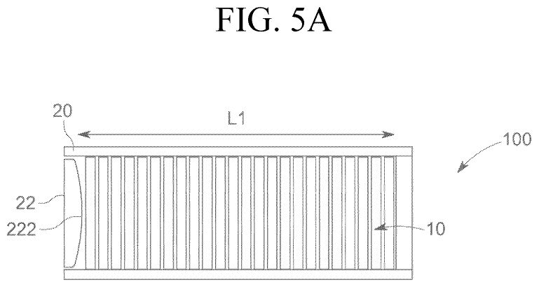

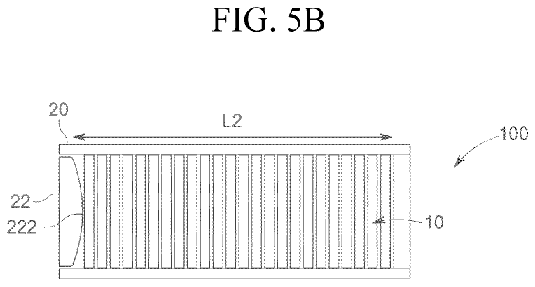

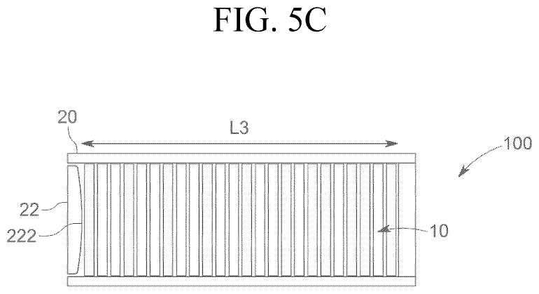

In the assembled state of the battery system 100 as shown in, for example, FIG. 1, the Belleville spring portion 222 extends from the base portion 221 towards the cell stack 10, thereby exerting pressure onto the cell stack 10. Accordingly, the Belleville spring portion 222 may be deformed depending on the length of the cell stack 10 as shown in, for example, FIGS. 5A-5C.

Due to production tolerances of the battery cells 12 and of any cell spacers (if present) arranged between the battery cells 12, the length of the cell stack 10 may vary. For example, during production, the produced cell stacks may not have the same length. Also, the battery cells 12 of the cell stack 10 may swell due to ageing, thereby expanding along the axis X and increasing the length of the cell stack 10. The cell stack frame 20, according to embodiments of the present disclosure, may compensate for these different lengths of the cell stack 10 due to the deformable end plate 22 with its Belleville spring portion 222.

As shown in FIGS. 5A-5C, the Belleville spring portion 222 is deformed to different degrees depending on the cell stack length. In FIG. 5A, the cell stack 10 has a first length L1, in FIG. 5B, the cell stack 10 has a second length L2, and in FIG. 5C, the cell stack 10 has a third length L3, wherein the second length L2 may be a minimal length, the third length L3. The third length L3 is a maximum length, and the first length L1 is a nominal length such that L3>L1>L2. For the cell stack 10 having the minimal length L1, the Belleville spring portion 222 is only slightly deformed (see, e.g., FIG. 5B). For the cell stack 10 having the maximum length L3, the Belleville spring portion 222 is heavily deformed (see, e.g., FIG. 5C). For the cell stack 10 having the nominal length L2, the Belleville spring portion 222 is moderately deformed (see, e.g., FIG. 5A). Nevertheless, the deformable end plate 22 may exert substantially the same pressure onto the cell stack 10 via its Belleville spring portion 222 independent of the length of the cell stack 10. The cell stack frame 20 with its deformable end plate 22 may be configured to ensure the correct pressure conditions for optimal operation of the battery cells 12 over their entire lifetime.

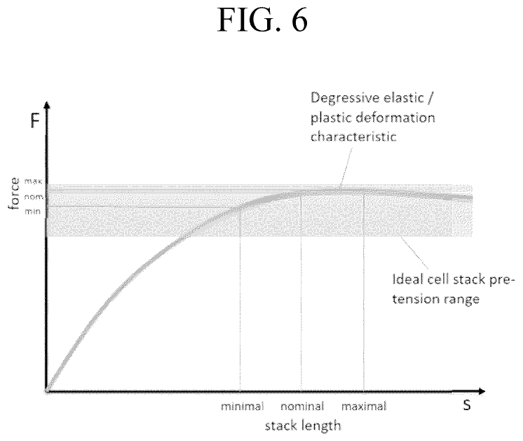

In contrast to conventional battery systems, which may include end plates having a rigid linear or progressive elastic pressure characteristic, the deformable end plate 22 according to embodiments of the present disclosure has, due to the Belleville spring portion 222, a degressive elastic/plastic deformation characteristic. As shown in FIG. 6, the degressive deformation characteristic may include a low, or even flat, force-displacement-inclination in the relevant, advantageous pre-tensioning force range for prismatic or pouch type cells.

FIG. 6 is a diagram showing a force F to elongation (e.g., displacement) s ratio for the deformable end plate 22, that is, for the Belleville spring portion 222 of the deformable end plate 22. As shown, the curve has a degressive shape in which the force (and, thus, the pressure) exerted by the Belleville spring portion 222 onto the cell stack 10 stays within a window or range of an ideal cell stack pre-tension for the different cell stack lengths, for example, as shown in FIGS. 5A-5C.

Thus, the deformable end plate 22 with its Belleville spring portion 222 may compensate for inevitable tolerances for both the elements of the cell stack 10 as well as the elements of the cell stack frame 20. This may eliminate the need for additional shimming or other adjustment work during cell stacking. Further, any swelling of the battery cells 12 of the cell stack 10 may be compensated. Also, loads which may occur during accidents may be compensated. The deformable end plate 22 may thereby exert substantially the same pressure, via its Belleville spring portion 222, onto the cell stack 10 independent of the length of the cell stack 10. Thus, the cell stack 10 may be kept in the optimum pressurization range for peak performance, ensuring reliable and safe operation through all its life cycle until end of life. Due to its Belleville spring portion 222, the end plate 22 may be mounted at the same fixture position without adjustments while keeping the cell stack 10 pre-tension in the desired range.

Some Reference Symbols

| | | | |
|---|---|---|---|
| 10 | cell stack | 12 | battery cells |
| 20 | cell stack frame | 22 | deformable end plate |
| 23 | end plate | 24 | side wall |
| 25 | side wall | 100 | battery system |
| 221 | base portion of deformable | | |
| | end plate | | |
| 222 | Belleville spring portion | | |
| | of deformable end plate | | |
| 223 | lateral edges | 224 | wall elements |
| 226 | central opening | 228 | slots |
| 230 | slots | X | axis |

What is claimed is:

1. A battery system comprising:
a cell stack comprising a plurality of battery cells; and
a cell stack frame accommodating the cell stack, the cell stack frame comprising:
a deformable end plate comprising a base portion; and
a Belleville spring portion extending from the base portion toward the cell stack that exerts pressure onto the cell stack.

2. The battery system as claimed in claim 1, wherein the deformable end plate has a rectangular shape corresponding to a shape of an interior space of the cell stack frame that accommodates the cell stack.

3. The battery system as claimed in claim 1, wherein the cell stack frame further comprises side walls, and
wherein the base portion of the deformable end plate is fixed to the side walls.

4. The battery system as claimed in claim 1, wherein the Belleville spring portion of the deformable end plate comprises four or more wall elements extending from the base portion of the deformable end plate toward a center of the Belleville spring portion.

5. The battery system as claimed in claim 1, wherein the Belleville spring portion has a central opening at a center of the Belleville spring portion.

6. The battery system as claimed in claim 5, wherein the Belleville spring portion has slots extending outwardly from the central opening of the Belleville spring portion.

7. The battery system as claimed in claim 6, wherein the slots extend radially outwardly the central opening of the Belleville spring portion.

8. The battery system as claimed in claim 6, wherein the slots are first slots, and
wherein the Belleville spring portion has second slots extending inwardly from lateral edges of the Belleville spring portion.

9. The battery system as claimed in claim 1, wherein the Belleville spring portion comprises slots extending inwardly from lateral edges of the Belleville spring portion.

10. The battery system as claimed in claim 9, wherein the slots are second slots,
wherein the Belleville spring portion has a central opening at a center of the Belleville spring portion, and
wherein the Belleville spring portion has first slots extending outwardly from the central opening of the Belleville spring portion.

11. The battery system as claimed in claim 10, wherein the first slots extend radially outwardly the central opening of the Belleville spring portion.

12. An electric vehicle comprising the battery system as claimed in claim 1.
